(19) United States
(12) Patent Application Publication
(10) Pub. No.: US 2010/0102822 A1
(43) Pub. Date: Apr. 29, 2010

(54) PROCESS AND DEVICE FOR MEASUREMENT OF SPECTRAL INDUCED POLARIZATION RESPONSE USING PSEUDO RANDOM BINARY SEQUENCE (PRBS) CURRENT SOURCE

(76) Inventors: Tadepalli Rammohan Prasad, Andhra Pradesh (IN); Boppana Dasaradha Ramayya, Andhra Pradesh (IN); Yelamanchili Purnachandra Rao, Andhra Pradesh (IN)

Correspondence Address: LADAS & PARRY LLP, 26 WEST 61ST STREET, NEW YORK, NY, 10023, US

(21) Appl. No.: 12/521,913

(22) PCT Filed: Dec. 26, 2007
(86) PCT No.: PCT/IN07/00603

§ 371 Date: Jul. 1, 2009

(30) Foreign Application Priority Data
Jan. 3, 2007 (IN) 30/DEL/2007

(51) Int. Cl. G01V 3/00

(52) U.S. Cl. 324/354

(57) ABSTRACT

A process and device for measurement of spectral induced polarization response of subsurface over a wide band of frequencies (0.03 Hz to 100 Hz) using pseudo noise current source, is provided. (Pseudo Random Binary Sequence current source). The measurement setup employs a current source (500 VA) and a computer controlled real time correlator for excitation of the subsurface. The current from the source is reversed through the grounded electrodes in a Pseudo Random Binary Sequence (PRBS) and the computer based receiver essentially computes Auto (input-input) and Cross (input-output) correlation estimates in the field. The collected data (time series) is transformed into frequency domain (DFT) in order to obtain the phase spectrum. The receiver has a provision to stack data for an improved S/N ratio. Measurements taken in laboratory using simple RC network, which simulates the subsurface, are accurate. Accuracy of measurement is better than 2% in Band-I (0.031-2 Hz) and 1% in Band-II (2-100 Hz) respectively.

### FIELD OF THE INVENTION

The present Invention relates to development of a process and device for the measurement of spectral induced polarization response using Pseudo Random Binary Sequence (PRBS) current source.

The main utility of the invention is to take spectral induced polarization measurements in the field. These measurements are used in the exploration of minerals, ground water and hydrocarbons. These measurements will enable to understand mineral texture and discrimination of economic mineralization from barren halos. Moreover they are also useful in the environmental applications such as mapping of zones with some organic contaminants in the soil.

### BACKGROUND AND PRIOR ART OF THE INVENTION

Conventional methods in taking induced polarization measurements are Frequency domain wherein measurements are taken at selected frequencies (FIG. 4-a) and time domain wherein measurements are taken from decaying wave form (FIG. 3-b).

Considerable time and energy is expended for taking measurements in frequency domain. In time domain even though data acquisition is faster and contains wide band information, the signal to noise ratio deteriorates at later times. Also tellurics contribute as a major source of noise while taking above measurements.

The response of the ground to an externally applied excitation is measured at one or more frequencies and one or more samples of transfer function are obtained in the frequency domain. The complete information about the behavior of the system requires measurements on infinite range of frequencies, starting from d.c. which is evidently not possible in practice, and is not even useful for the purpose of exploration. The relevant information in which geophysicists are interested commonly lies in a certain band and it is enough to find the transfer function over the range of that band.

The instruments used for taking the measurements of frequency domain are Ipt-6 high power current source and v-2 induced polarization receiver of Phoenix geophysics ltd, Canada and transmitter ggt-30 and receiver gdp-32 rpip of Zonge engineering research organization, Canada.

Similarly, measurements in the time-domain with a repetitive non-sinusoidal wave form provide the information effectively over a limited frequency range of excitation because in practice it is not possible to measure over an infinite time interval. Generally, samples of transient waveform at short periods after each switching-off of excitation current mainly represent the high frequency response of the system, and late samples mainly represent the low frequency response. Hence the effective frequency window of observation depends on the methodology adopted in sampling of the transient waveform governed by the nature of excitation.

The instruments used for taking the measurements of time domain are Tsq3 time and frequency domain IP transmitter and ipr-10a time domain I.P receiver of Scintrex, Canada and Transmitter ggt-30 and receiver gdp-32 tdip of Zonge engineering research organization, Canada.

In the present invention a Pseudo Noise current source is employed for excitation of the ground in order to harness the advantages of even distribution of energy over wide band of frequencies in the spectrum and also to conserve energy, the input spectrum is tailored by selecting the period of the clock and length of sequence. The electrical transfer function of the subsurface is derived in the field from input-input (auto) and input-output (cross) correlation estimates.

### OBJECTS OF THE INVENTION

The main object of the present invention is to provide a process and a device for measurement of spectral induced polarization response using Pseudo Random Binary Sequence (PRBS) current source” which obviates the drawbacks as detailed above.

Another object of the present invention is to provide a process for measurement of complex resistivity in field using pseudo noise source.

Still another object of the present invention is to provide a device for exploration of disseminated ore bodies, ground water, hydrocarbons and pollution studies.

Yet another object of the present invention is to provide a device capable of exciting the sub surface over a wide band of frequencies preferably over two or three decades, with power distributed evenly over the entire band.

A further object of the present invention is to provide a device with provision to tailor the band width of excitation as per application.

A still further object of the present invention is to provide a device which improves the signal/noise ratio (s/n) of the measured signal in addition to the ability to reject the uncorrelated noise, like “tellurics” in field.

Still yet another object of the present invention is to provide a device which is capable of obtaining IP phase angle spectrum over useful and normal band of frequencies at a time in the field.

### SUMMARY OF THE INVENTION

Accordingly, the present invention provides a device for the measurement of spectral induced polarization response using Pseudo Random Binary Sequence (PRBS) current source, which comprises a PRBS current source and a receiver, the said current source includes an alternator (1) connected to a high voltage supply (2) and also to a low voltage power supply (3), which is further being connected to insulated gate bipolar transistor (IGBT) driver (7), the said driver (7) being connected from one side to three inter-connected components, consisting of Precision GPS time and frequency reference (4), scalar/divider (5) and PRBS generator (6), and from the other side being connected to IGBT current switching bridge (8) for the excitation of the subsurface, the said receiver system being a digital correlator of reference and signal channels for computing electrical transfer function of the subsurface which includes precision GPS time and frequency reference (9) connected to scalar/divider (10), which is further being connected to PRBS generator (11), the said generator (11) being further connected to a sample timer (10), pre-amplifier (13), SP compensator (13), amplifier (14) and matched anti-aliasing filters (12,15), the said filter being further connected to a Multi-function data acquisition Personal Computer memory card international Association Card (PCMCIA) (16) and a lap top computer (17).

In an embodiment of the present invention, a process for measurement of spectral induced polarization response using Pseudo Random Binary Sequence (PRBS) current source is provided, wherein the uncorrelated noise is rejected by using correlation method; and thereby signal/noise ratio is improved substantially as the stacking process is used, gives the phase angle of the subsurface over useful and normal band of frequencies at a time in the field.

In another embodiment of the present invention, high voltage power supply (2) provides a DC Voltage up to 500 Volts at 1 A to the IGBT bridge.

In yet another embodiment of the present invention, low voltage power supply (3) as +12 Volts DC is supplied to IGBT bridge driver circuit.

In a further embodiment of the present invention, precision GPS time and frequency references (4, 9), generate stable (1 in 10″) 10 MHz clock and feed to scalar/divider. In another embodiment of the present invention, scalar/divider (5, 10) generates 200 Hz 4 Hz clocks.

In another embodiment of the present invention, PRBS generator (6, 11) input is taken from Scalar/divider and Pseudo Random Binary Sequences of lengths 31, 63 and 127 are generated.

In yet another embodiment of the present invention, IGBT driver (7) trigger pulses as per the input PRBS sequence are generated.

In another embodiment of the invention, IGBT current switching bridge (8) current is switched alternately (+ −) into the ground through current electrodes (AB) on getting trigger pulses from the driver.

In one more embodiment of the invention, over load protection built into the IGBT driver (7) current is sensed and triggers to the IGBT bridge are switched OFF in case current exceeds the limit.

In a further embodiment of the invention, signal from potential electrodes (MN) is amplified 10 times by the pre-amplifier (13) with low noise output, simultaneously providing high input impedance.

In yet another embodiment of the invention, SP compensator (13) self potential of the ground up to maximum of +750 mV to −750 mV is cancelled.

In one more embodiment of the invention; output signal from the pre-amplifier is further amplified by amplifier (14) in steps of 1, 10 and 100 which can swing up to ±5 Volts.

In yet another embodiment of the invention, sample timer (10) sampling pulses for Data acquisition and clock pulses for anti aliasing filters are generated.

In another embodiment of the invention, data acquisition card (16) residing in PCMCIA slot of laptop computer analog samples from reference and signal channels are converted into digital data with 16 bit resolution.

In a further embodiment of the invention, auto and cross correlation estimates of acquired data are computed.

In one more embodiment of the invention, sub-surface is excited with PRBS current waveform, the power distributed evenly through out the band 0.03 Hz to 100 Hz and provision is made to tailor the band width of excitation as per the application.

### BRIEF DESCRIPTION OF THE DRAWINGS

In the drawings accompanying this specification

FIG. 1-(a) represents determination of unit impulse response of a linear System by correlation method.

FIG. 1-(b) represents determination of unit impulse response of a linear System under disturbance

FIG. 2 represents general field set up for Induced polarization measurements

FIG. 3-(a) represents Interrupted Bipolar current switching into the subsurface for taking measurements in time domain

FIG. 3-(b) represents recorded decaying voltage across potential electrodes (MN) after current is switched off

FIG. 4-(a) represents phase difference between injected current (AB) and recorded voltage (MN) for taking measurements in frequency domain

FIG. 4-(b) represents alternate use of bipolar square wave energization

FIG. 4-(c) represents power spectrum of FIG. 4-(b)

FIG. 5 represents typical plot of magnitude and phase spectrum of complex resistivity of polarizable target in the subsurface

FIG. 6-(a) represents an example of 63 clock length Pseudo Random Binary Sequence

FIG. 6-(b) represents the auto correlation plot of PRBS

FIG. 6-(c) represents the power spectrum of PRBS

FIG. 7-(a) represents block diagram of PRBS current source (500 VA capacity; 500V, 1 Amp; 100V, 5 Amps)

FIG. 7-(b) represents block diagram of receiver

FIG. 8-(a) represents auto and cross correlation estimate plots of RC network used for simulating a target in the subsurface using device

FIG. 8-(b) represents phase spectrums of RC network (to simulate a target in the Subsurface) both experimental and theoretically computed

FIG. 9 represents process flow chart of device

FIG. 10 represents flow chart of main program

FIG. 11 represents flow chart of SP measurement and cancellation program

FIG. 12 represents flow chart for measurement of magnitude and phase program

Table 1 represents spectrum, clock frequency and sequence length of excitation

### DETAILED DESCRIPTION OF THE INVENTION

The present invention provides a process and a device for measurement of spectral induced polarization response using Pseudo Random Binary Sequence (PRBS) current source, which comprises PRBS current source, which includes an alternator to derive power, high voltage power supply for feeding the DC power to the insulated gate bipolar transistor (IGBT) bridge, low voltage power supply to power the IGBT driver circuit, precision GPS time and frequency reference for deriving 10 MHz clock, scalar/divider to feed clock to the PRBS generator, PRBS generator to generate PRBS sequence, IGBT driver to drive IGBT's of the bridge, IGBT current switching bridge to switch current in to the sub-surface through current electrodes and receiver system, essentially a digital correlator of reference and signal channels for computing electrical transfer function of the subsurface, which includes precision GPS time and frequency reference which is synchronized with current source, generates 10 MHz clock that is fed as input to scalar/divider, scalar/divider provides clock to PRBS generator, PRBS generator outputs a sequence identical to that of current source as an input to reference channel, sample timer to provide sampling pulses to data acquisition card, pre-amplifier of signal channel to provide high input impedance and gain for the signal received from subsurface through potential electrodes(MN), SP compensator to cancel the self potential across potential electrodes, amplifier for improving the signal level, matched anti aliasing filters one for signal channel, another for reference channel for removing aliasing effects, Multi function data acquisition Personal Computer memory card international Association Card (PCMCIA) to sample and convert signal and reference inputs to digital form, lap top computer to acquire and store in memory through PCMCIA card, software developed relating to data acquisition, auto and cross correlation, stacking, Discrete Fourier Transform (DFT) and operator interactive soft ware to enter parameters and display the results.

In accordance to an embodiment of the present invention, process employs a pseudo noise current source (Pseudo random binary sequence) for excitation of sub surface (ground) and auto & cross correlation estimates of the received signal for obtaining the transfer function of the subsurface. The energy of the excitation waveform is distributed evenly over the entire band of frequency (0.03 Hz-100 Hz). The sub surface is excited with the above excitation waveform. The band-width of the excitation can be tailored as per the application. Voltage samples are picked up by the receiver electrodes and also from reference waveform which is synchronized with the excitation wave form. The above samples are used for arriving at input-input (Auto) and Input-output (Cross) correlation estimates. The electrical transfer function of the subsurface is obtained by transforming the auto and cross correlation estimates in to frequency domain by DFT Software. The transfer function in the form of frequency versus phase and frequency versus magnitude is plotted in the field it self. Signal to noise ratio is improved in addition to the rejection of uncorrelated noise. The uncorrelated noise in this case is “Tellurics” in the field. The induced polarization (IP) phase angle spectrum is obtained over useful normal band of Frequencies at a time in the field. The mean accuracy of measurements is better than 1% in Band-I and better than 2% in Band-II respectively.

In accordance to another embodiment of the present invention current source of the device switches PRBS current waveform in to the subsurface and lap top computer based receiver of the device acquires, processes the data, computes and display the electrical transfer function of the subsurface on the screen in the field itself.

In accordance to yet another embodiment of the present invention current source and receiver are synchronized using precision GPS time and frequency references in order to eliminate physical linking between current source and receiver through a cable.

In accordance to still another embodiment of the present invention software developed performs the functions of data acquisition, display of SP measurement and cancellation, computation of auto and cross correlation estimates, stacking (to improve signal to noise ratio), DFT (for obtaining phase and magnitude spectrum),data transfer and operators interactions (to enter parameters and display of results).

The present invention employs a pseudo noise current source for excitation of the ground and extracts the electrical transfer function of the subsurface from the input-input (auto) and input-output (cross) correlation estimates derived in the field. Van Voorhis etal (1973) and Pelton etal (1978) have shown that complex Resistance of polarizable target may be expressed as

Z(ω)=R₀{1−m[1−1/1 +(i ωt)^{C}]}

Where, Z (ω)—complex resistance, R₀—constant (Resistance at zero frequency) m—Chargeability, t—time constant, ω—angular frequency, C—value ranges from 0.25-0.5

Various models have been examined by the above authors and it is shown that it is a simple cole-cole model that describes a symmetrical ‘peak’ in a plot of log phase Vs log frequency. The ‘peak’ in the I.P phase angle spectrum as regards to it's magnitude and location along the frequency scale appears to be caused by the type of texture, grain size, and sulfide concentration (Nelson, P. H. etal.)

Application of pseudo noise (p-n) sequences whose auto correlation approaches an impulse is well known in Geophysics. The works of Foster & Sloane (1972) in neutron logging, Quincy etal. (1974), Duncan, P. M., etal (1980)in the application of wide band e.m sounding problems bring out clearly the ease with which maximal length sequences can be generated and also the advantages of such sources as regards the more even distribution of energy over wide band of frequencies in the spectrum. In order to conserve energy, the input spectrum can be tailored by choosing the period (T) of the clock and the length (n) of the sequence.

The input-output cross correlation φᵢₒ (τ) of a linear system with random Stationary input θᵢ(t) and output θₒ (t)_{according} to definition is

$${φ}_{io} ( τ ) = {Lim}_{T -> ∞} 1 / 2 T {\int }_{- T}^{+ T} fi ( t ) fo ( t + ⊤ ) d t \qquad ( 1 )$$

the above eqn, can be written as

$${φ}_{io} ( τ ) = {Lim}_{T -> ∞} 1 / 2 T {\int }_{- T}^{+ T} fi ( t ) d t {\int }_{- ∞}^{+ ∞} h ( v ) fi ( t + τ - v ) d v \qquad ( 2 )$$

by inverting the order of integration, we have

$$\begin{matrix}{φ}_{io} ( τ ) = {\int }_{- ∞}^{+ ∞} h ( v ) d v {Lim}_{T -> ∞} 1 / 2 T {\int }_{- T}^{+ T} fi ( t ) fi ( t + τ - v ) d t \\ Since & ( 3 ) \\ {φ}_{ii} ( τ - v ) = {Lim}_{T -> ∝} 1 / 2 T {\int }_{- T}^{+ T} fi ( t ) fi ( t + τ - v ) d t & ( 4 )\end{matrix}$$

eqn (3) can be written as

$${φ}_{io} ( τ ) = {\int }_{- ∝}^{+ ∝} h ( v ) φ ii ( τ - v ) d v \qquad ( 5 )$$

Taking Fourier transform both sides, we have

$$1 / 2 \cdot π {\int }_{- ∝}^{+ ∝} {φ}_{io} ( τ ) {e}^{- j ω τ} d τ = 1 / 2 π {\int }_{- ∝}^{+ ∝} {e}^{- j ω τ} d τ {\int }_{- ∝}^{+ ∝} h ( v ) φ ii ( τ - v ) d v \qquad ( 6 )$$

which yields,

ψio (ω)=H(ω) ×ψii (ω) (7)

where ψᵢₒ(ω) and ψᵢᵢ(ω) are the cross and Auto power density spectrums respectively.

This result shows that the cross power density spectrum of a linear system is the product of system function and the Auto power density spectrum. Above Eqn can be written as

H(ω)=ψᵢₒ(ω)/ψᵢᵢ(ω) (8)

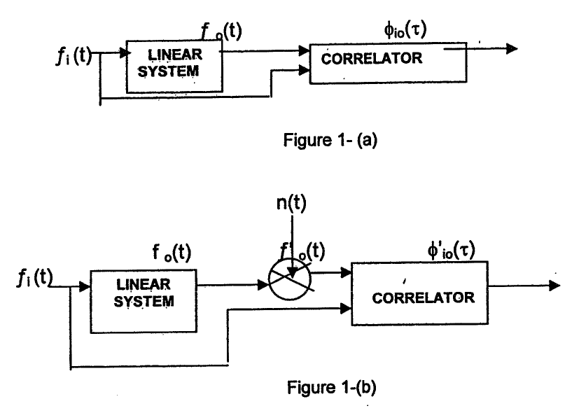

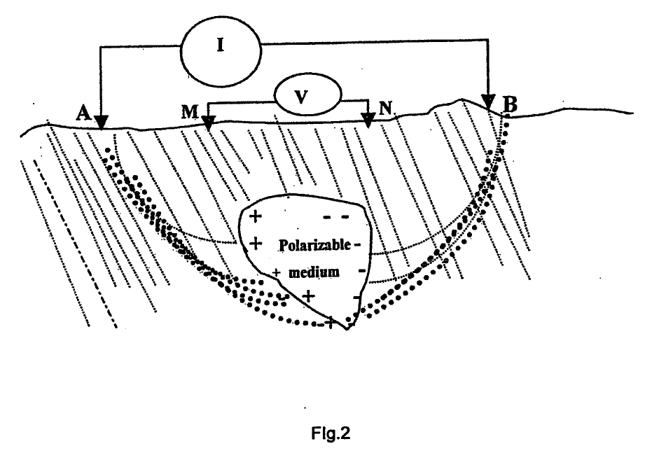

In eqn. (7) & (8), the phase spectrum of ψᵢₒ(ω) is that of H(ω) and since φᵢᵢ(ω) has zero phase spectrum and the amplitude spectrum of ψᵢₒ (ω) is the product of the amplitude spectrum H(ω) and ψᵢᵢ (ω). FIG. 1-(a) & FIG. 1-(b) Illustrates the manner in which Interfering signals, which bear no relation to the test signal, are eliminated by the averaging action of the correlator integral. Thus if the output ƒ′ₒ (t) consists of the wanted signal ƒₒ (t) with added noise component n (t), the cross correlation function Φ′ᵢₒ(τ) consists of two terms φᵢₒ(τ) and φᵢₙ(τ) . If, ƒᵢ (t) and n(t) are un correlated, then φᵢₙ(τ)=0. Therefore,

φ′ᵢₒ(τ)=φᵢₒ(τ)+φᵢₙ(τ)≈φᵢₒ(τ) (9)

and hence the result is unaffected by interfering noise.

The technique is expected to reject ‘Tellurics’, which constitutes a major source of noise in I.P exploration. Also, the process of removal of inductive coupling effects in the field can be made very effective as the discrete phase spectrum obtained is composed of several closely spaced frequencies.

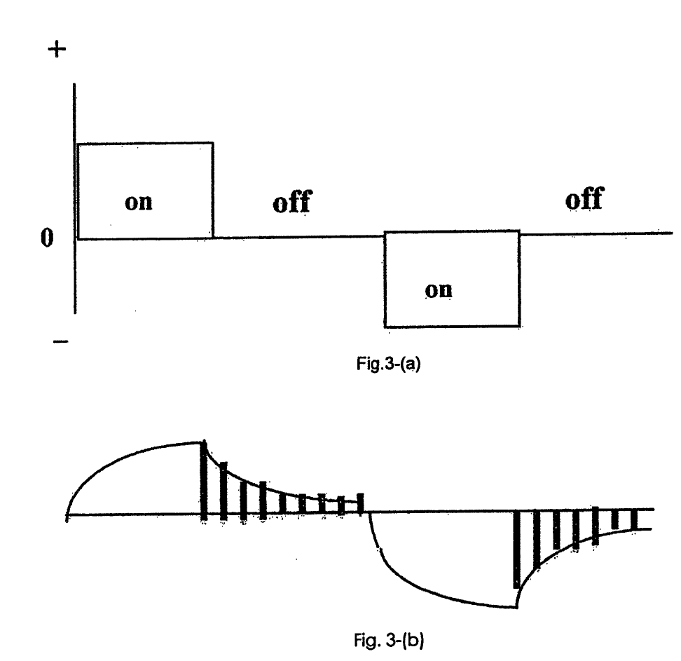

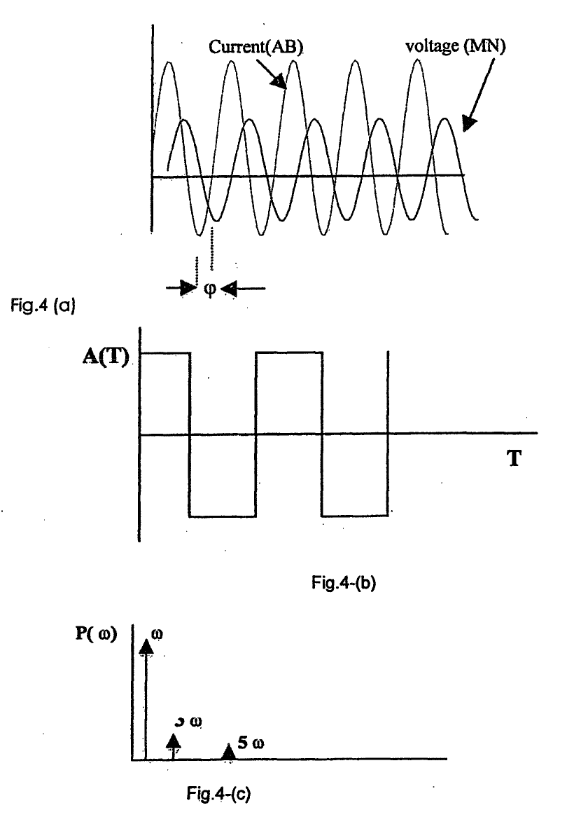

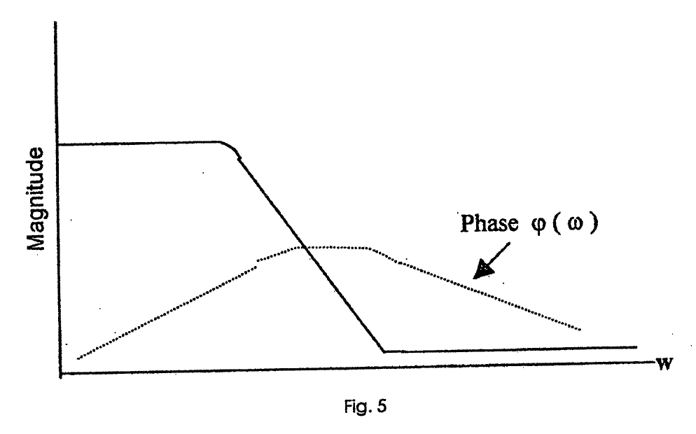

Conventionally available IP field survey equipment contains provision to make measurements at a number of selected frequencies in the frequency domain (FIG. 4-a) or measure the samples of decaying waveform (FIG. 3-b) in time domain. As a result, while considerable time and energy is expended for making several measurements in frequency domain, the acquisition of data in the time domain, though faster, contains wide band information and signal to noise ratio(s/n) deteriorates at later times. Also ‘Tellurics’ constitutes a major source of noise in field. Hence it is desirable that the device is used for taking Spectral Induced Polarization (SIP) measurements has the following features:
1. Excitation of subsurface over a wide band of frequencies, preferably over two or three decades, with power distributed evenly over the band,
2. Provision to tailor the band width of excitation as per the application,
3. Improves signal to noise ratio (s/n) of measured signal in addition to the ability to reject uncorrelated noise in field and
4. The IP Phase angle spectrum over useful and normal band of frequencies is obtained at a time in the field.

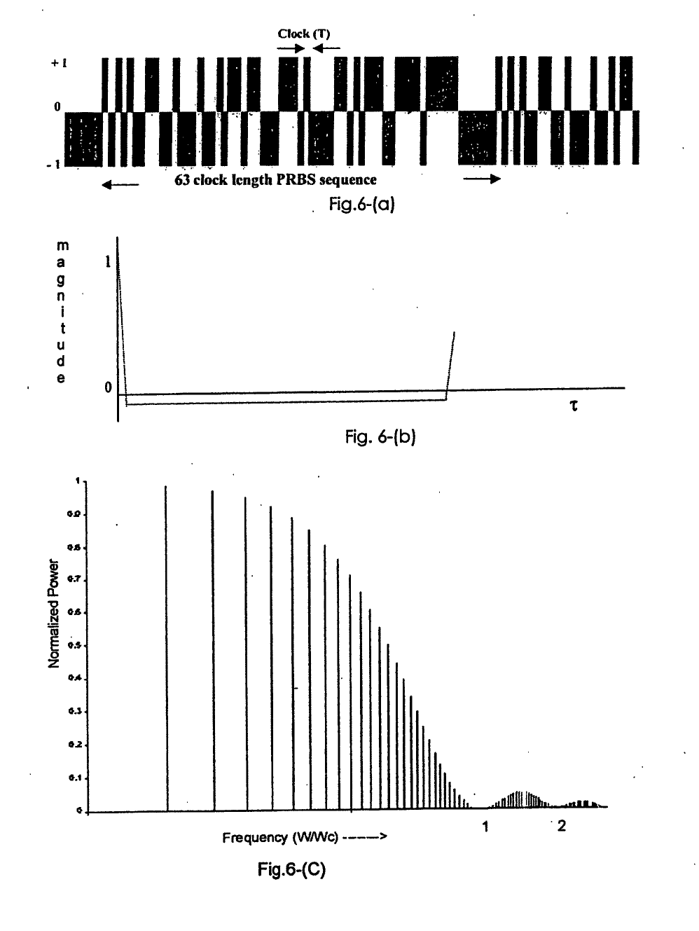

The selection of the Pseudo Random Binary Sequence (PRBS) current for subsurface energisation (FIG. 6-a) appears appropriate and fulfills the requirements mentioned above. Two freely adjustable parameters ‘fc’, the clock frequency and ‘n’, the sequence length parameter characterize the PRBS. The sequence repeats after 2ⁿ−1 clocks. In FIG. 6-(a), ‘n’ is equal to 5 and the PRBS repeats after 63 clocks. The auto-correlation function of PRBS appears as a comb of repeated triangles as shown in FIG. 6-(b) and as n→∞ the autocorrelation approaches an impulse. The power spectrum of the PRBS (FIG. 6-c) which is a Fourier transform of the autocorrelation function and consists of lines equally spaced in frequency by fc/2ⁿ−1, the envelope being Sinc² function having its first zero at the clock frequency fc. The measured data are cross-correlation estimates between the observed voltage at the potential electrodes (MN) and an exact copy of the PRBS current injected into the subsurface through current electrodes (AB). If both ‘n’ and ‘fc’ are large, these estimates make up the ‘impulse response’ of the earth (subsurface) for keeping aliasing effects to minimum. The signal channel consists of low noise front end amplifier with nominal (x 10) gain and provision to compensate for SP (Self potential) across potential electrodes (MN). The anti-aliasing filter present in this channel is matched to better than 0.5% to the filter in reference channel.

The input to the digital correlator are the samples fi (kT) of the sequence of reference channel (CH0) and f0(kT) of signal channel (CH1). The correlator computes the Auto and Cross correlation estimates. A laptop computer based equipment was developed for measurement of spectral induced polarization response of subsurface (complex resistivity). Correlation techniques were used to obtain the transfer function of the subsurface (ground). Development of the equipment can be broadly classified into two parts, hardware and software. Hardware is further divided into PRBS (Pseudo random binary sequence) Current source and laptop computer based Receiver.

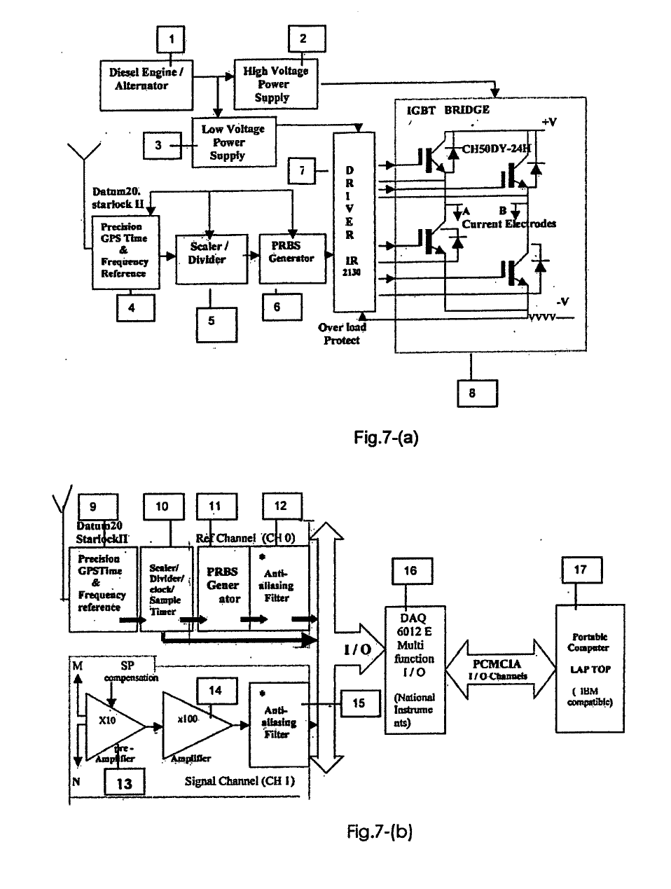

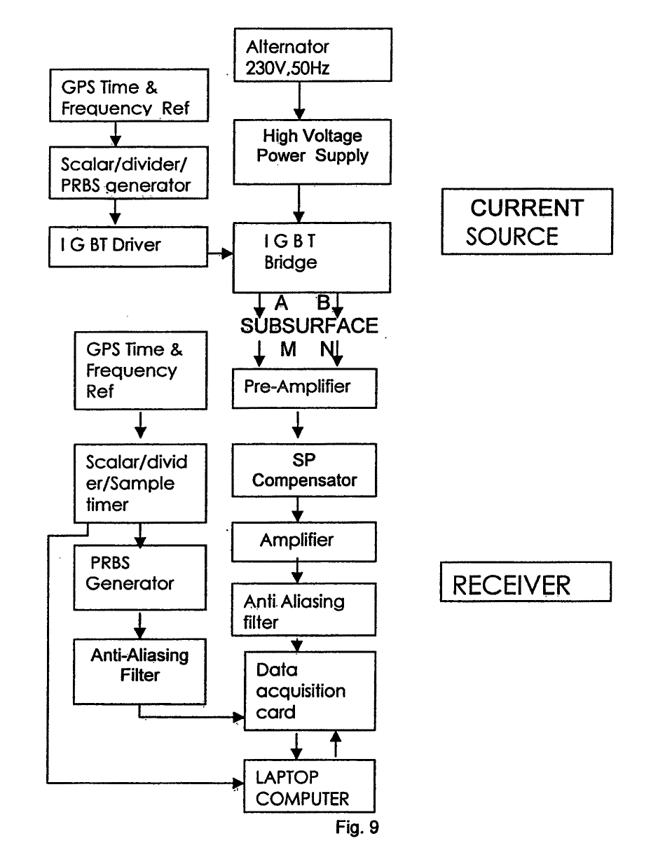

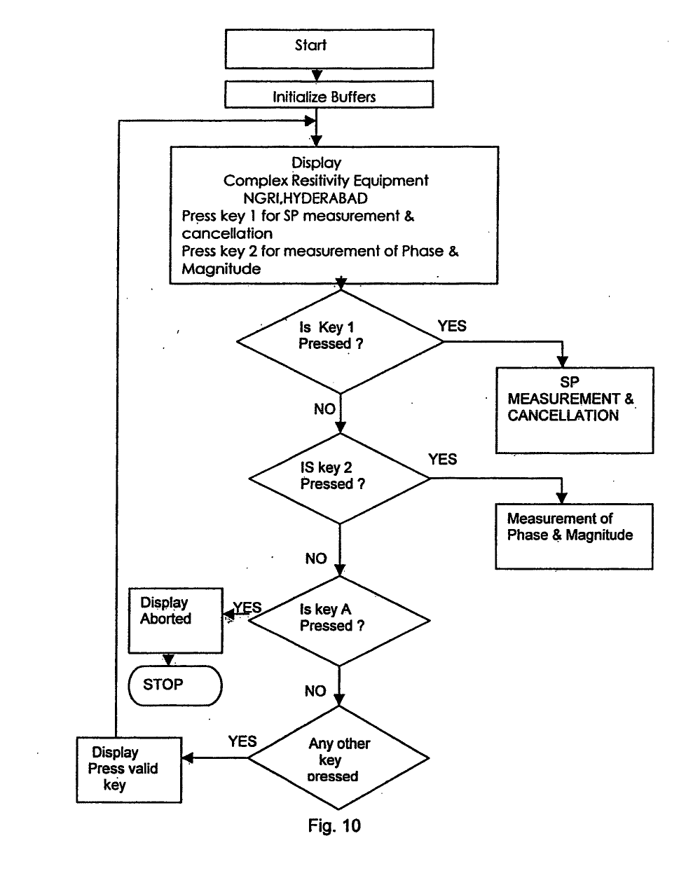

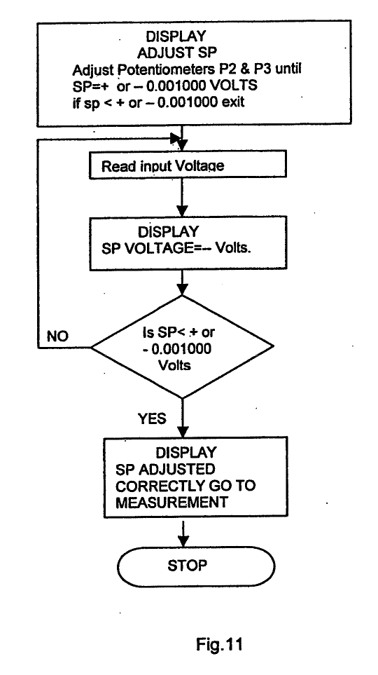

The block diagram of the current source is shown in FIG. 7-(a) and flow chart of the process as shown in FIG. 9. Power is derived from alternator (1) 230 Volts, 50Hz, 1 Kva. The voltage from the generator is converted into 100V-500V DC in steps of 100 Volts using 500 VA transformer, 600 Volts, 5 A bridge rectifier, 200 mh 5 A choke and 450 μf/800 Volts filter capacitor (2). This DC voltage is fed to IGBT (Insulated Gate Bipolar transistor) bridge (8). Low voltage power supply (3) 12 Volts, 0.5 Amps DC is derived using low voltage transformer, Low power bridge rectifier and LM7812 Voltage regulator. This DC Voltage is used as power supply to IGBT Driver (7) circuit (IR 2130). 10 Mhz output signal is derived from precision GPS (4) time and frequency generator (Datum STARLOC-II GPS) which is powered by 12 Volts, 7 AmpH battery. This signal is locked to the Satellite clock. The stability of the clock is 1 in 10″. This signal is fed to scalar/divider. The outputs of the scalar/divider are 4 Hz and 200 Hz. The outputs of the scalar/divider are fed as input to PRBS generator, consisting of 7 stage shift register, exclusive NOR gate. The PRBS is generated using shift register chain and there is a provision to select ‘fc’, the clock frequency and ‘n’, the sequence length parameter to tailor the bandwidth of the input (excitation) spectrum as shown in table I. The output of the PRBS generator is fed to the IGBT driver circuit. The IGBT driver circuit conditions the input to drive IGBT bridge appropriately. The IGBT bridge consists of four (Mitsubishi, CH50DY-24H) IGBT'S. The bridge switches PRBS current waveform into the ground with maximum capacity of 500 Volts, 1 Amp or 100 Volts, 5 Amp through current electrodes A B. The over load protection circuit built in the IGBT driver circuit switches off the triggers when current limit exceeds, to protect IGBT bridge. The applied DC Voltage and average current switched into the ground are displayed on the front panel LCD displays of the current source.

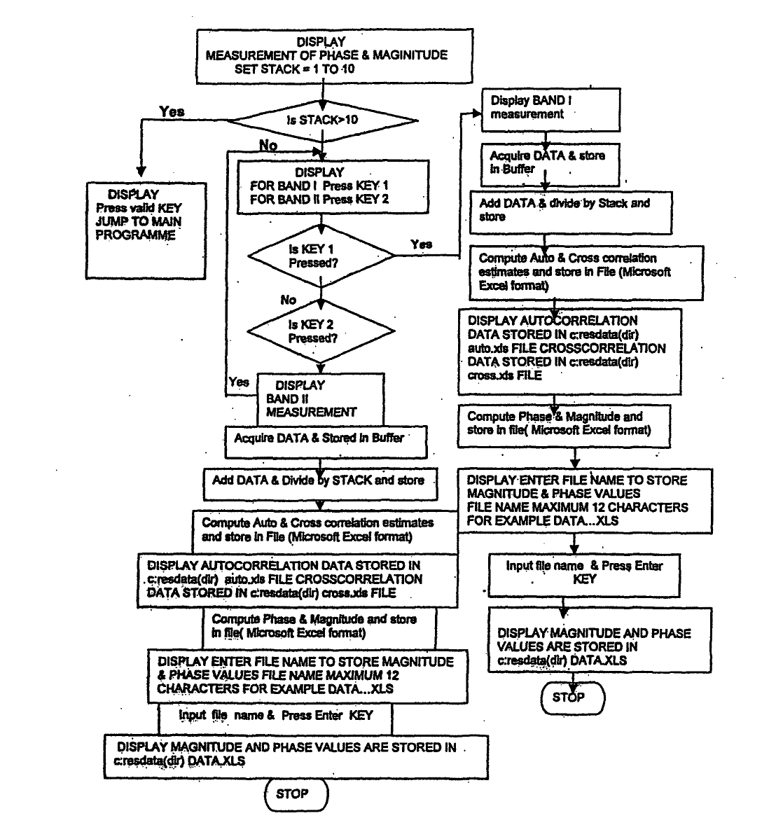

Receiver block diagram shown in FIG. 7-(b) and flow chart of the process is shown in FIG. 12 essentially a digital correlator and consists of two channels Reference channel and Signal channel. Second PRBS generator which is identical to the one described in the current source provides reference to the correlation. The clock input to this is obtained from the disciplined crystal oscillator of the 10 Mhz Precision GPS time and frequency reference unit (DATUM STARLOC-II) synchronized with the one described in the current source. Sampling and filter clock pulses are derived from scalar/divider. The reference signal is passed through a filter (5 th oder Butterworth low pass)for keeping aliasing effects to minimum. The signal channel (connected to potential electrodes MN) of low noise pre-amplifier with nominal gain (X10) and provision to compensate for the SP (Self Potential) across potential electrodes. Amplifier with the maximum gain of 100 further amplify the signal. The output of the amplifier is passed through the anti aliasing filter (which is matched to better than 0.5% to the filter in the reference channel). Data acquisition hardware/software consists of DAQ-6012E, multi function I/O (NATIONAL INSTRUMENTS) PCMCIA card that plugs directly in to the portable (laptop) computer. The PCMCIA card has 16 single channel or 8 fully differential inputs with 16-bit resolution A/D, PGIA (Programmable gain instrumentation amplifier), with external-and software trigger facility and maximum sampling rate of 200 K Samples/sec. The inputs to the digital correlator are the samples fi(kT) of the sequence of the reference channel (CH0) and fo(ki) of the signal channel (CH1).The correlator computes the auto correlation estimates.

$$φ ii ( m ⊤ ) = 1 / N {\sum }_{K = 0}^{N - 1} fl ( k ⊤ ) fl \{ ( k + m ) ⊤ \} \qquad ( 10 )$$

And Cross correlation estimate

$$φ io ( m ⊤ ) 1 / N {\sum }_{K = 0}^{N - 1} fl ( k ⊤ ) f 0 \{ ( k + m ) ⊤ \} , \qquad ( 11 )$$

These expressions show that for a given value of delay mT, it involves the summation of the products of each sample fo(ki) with a sample of fi(k-m)T which occurred ‘m’ samples earlier. The algorithm collects an array of samples of the reference and signal channel sequences (Eqn. 10 & 11) and after stacking (to improve the signal to noise ratio) computes the auto and cross correlation estimates. Consequently in a given time, very small signals can be measured. The time series φ ii and φ io are transformed into the frequency domain using the Discrete Fourier transform (DFT) and division of ψ io(ω) by ψ ii(ω) yields the desired frequency response of the sub surface H(ω).

$$1 / 2 \cdot π {\int }_{- ∝}^{+ ∝} {φ}_{io} ( τ ) {e}^{- j ω τ} d τ = 1 / 2 π {\int }_{- ∝}^{+ ∝} {e}^{- j ω τ} d τ {\int }_{- ∝}^{+ ∝} h ( v ) φ ii ( τ - v ) d v \qquad ( 12 )$$

which yields,

ψio(ω)=H(ω)×ψii(ω) (13)

where ψᵢₒ(ω) and ψᵢᵢ(ω) are the cross (input-output) power density spectrum and the Auto (input-input) power density spectrum, respectively. This result shows that the cross (input-output) power density spectrum of a linear system is the product of system function and the Auto (input-input) power density spectrum.

The above equation (13) can be written as

H(ω)=ψᵢₒ(ω)/ψᵢᵢ(ω) (¹⁴)

The phase spectrum of ψᵢₒ(ψ) is that of H(ω) and since ψᵢᵢ(ω) has zero phase spectrum. The amplitude spectrum of ψio (ω) is the product of the amplitude spectrum H (ω) and ψii (ω).

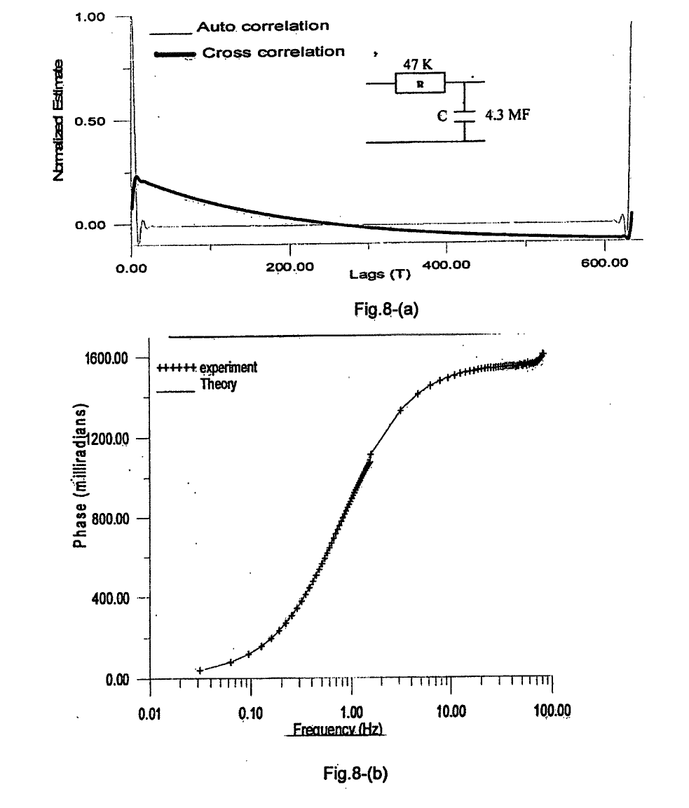

The software developed in C++ and NI-DAQ(National instruments) and windows 9x, consists of functions Data acquisition, Display of SP Measurement and cancellation, Auto and Cross correlation, Stacking to improve signal to noise ratio DFT software for obtaining phase and magnitude spectrum, Data transfer, Operators interactive software. Simulation measurements were taken with simple RC network. The auto and cross correlation estimates of the network are shown in FIG. 8-(a). From the auto (input-input) and cross (input-output) correlation data, phase and amplitude response (electrical transfer function) is obtained by transforming the data (time series) in to frequency domain (DFT).The phase spectrum of the RC Network is shown in FIG. 8-(b). The results show that on an average the measurements are accurate to better than 2% in Band I (0.03-2 Hz) and 1% in Band II (2-100 Hz).

TABLE 1
Spectrum, clock frequency and sequence length of excitation.

| | | Clock | | Correlation |
|---|---|---|---|---|
| | Frequency | Frequency | Sequence length | Interval |
| Band | Range(Hz) | fc(Hz) | 2ⁿ − 1 | (τ ms) |
| I | 0.03-2.0 | 4 | 127 | 50 |
| II | 1.60-100 | 200 | 127 | 1 |

The uncorrelated noise mainly like ‘Tellurics’ is rejected by using correlation method; signal/noise ratio is improved substantially as the stacking process is used, gives the phase angle of the subsurface over useful and normal band of frequencies at a time in the field, useful for exploration of disseminated sulphides, hydro carbons, useful for in-situ mineral discrimination studies, useful in the environmental applications such as mapping of zones with some organic contaminants in the soil, the removal of induction coupling effects is made very effective as the discrete phase spectrum obtained is composed of several close frequencies, conduct of field survey becomes easier and faster as current source and receiver are synchronized using precision GPS time and frequency references by eliminating cable connection and recovery of electrical transfer function of the subsurface with an accuracy of better than 2%.

The following example is given by way of illustration and therefore should not be construed to limit this scope of the present invention.

### EXAMPLE 1

PRBS Current source, PRBS Receiver, AC Power supply, Current and potential electrodes, Cables, 12 Volts, 7 AmpH batteries (2 numbers) and RC Network consisting of R=47KΩ, C=4.3 μ F (for simulating the sub-surface). The sequence of operational procedure for the conduct of the experiment in the laboratory is as under.

Connect the Current source and Receiver to respective power supplies i.e 230 Volts,50 Hz AC and 12 Volts, 7 AmpH batteries,

Set band switches of the both current source and receiver to Band I,

Set gain switch of the receiver in to 1 position,

Set Current source out put voltage switch in to 100 Volts position,

Connect the cable from Reset output of the Current source GPS clock to reset input of the Receiver GPS clock.

Connect the output terminals of the Current source to the input of RC network under test through a cable via an attenuator.

Switch ON the Current source, receiver and laptop computer.

Synchronize the shift register clocks of both Receiver and Current source by pushing the reset switch in the Current source.

Disconnect the reset cable.

Short the input terminals of the Receiver.

Click the “icon” titled Complex Resistivity on the desk top of the laptop computer. The following window is displayed on the screen.

COMPLEX RESISTIVITY EQUIPMENT
N G R I HYDERABAD

PRESS KEY 1 FOR SP MEASUREMENT & CANCELLATION
PRESS KEY 2 FOR MEASUREMENT OF PHASE AND MAGNITUDE

PRESS KEY A FOR ABORT

Press 1 and ENTER keys The following window is displayed on the screen.

ADJUST SP

Adjust Potentiometers P2 & P3 until

SP=+ or − 0.001000 VOLTS
If sp < + or − 0.003000 exit

Adjust potentiometers until the following message is displayed in the same
window.

SP ADJUSTED CORRECTLY GO TO MEASUREMENT

Remove the short between the input terminals of the receiver and connect them
to the output of the RC network under the test.
Press ENTER key. The following window is displayed again on the screen.

COMPLEX RESISTIVITY EQUIPMENT
N G R I HYDERABAD

PRESS KEY 1 FOR SP MEASUREMENT & CANCELLATION
PRESS KEY 2 FOR MEASUREMENT OF PHASE AND MAGNITUDE
PRESS KEY A FOR ABORT
Switch ON the high voltage switch of the Current source.
Press 2 and ENTER keys. The following window is displayed on the screen.

MEASUREMENT OF PHASE AND MAGNITUDE

SET STACK (1 TO 10)

Press 3 and ENTER keys. The following is displayed on the same window

STACK=3
FOR BAND I (0.03Hz-2Hz) press KEY 1
FOR BAND II (1.5Hz-100Hz) press KEY 2

Press 1 and ENTER keys. The following message displayed is displayed in the
same window.
BAND I MEASUREMENT

After the measurement is taken over the following message is displayed in the
same window

```
AUTO CORRELATION DATA STORED IN
  c: resdata (dir) auto.xls
CROSS CORRELATION DATA STORED IN
  C:resdata (dir) cross.xls
ENTER FILE NAME TO STORE MAGNITUDE & PHASE VALUES
FILE NAME MAXIMUM 12 CHARACTERS FOR EXAMPLE DATA-.XLS
```

Input file name DATA.XLS and press enter key. The following message is
displayed in the same window.

MAGNITUDE AND PHASE VALUES ARE STORED IN

C: resdata (dir) DATA.XLS

By using MS-EXCEL software the frequency versus phase curve is plotted.

The above procedure is repeated for Band-II measurements. By conducting above experiment transfer function of the RC network (which simulates ground) is obtained in the laboratory. The theoretically computed transfer function of the same RC network is also plotted along with the experimental curve as shown in FIG. 8-(b)

The main advantages of the present invention are:
1) Excitation of subsurface over a wide band of frequencies, preferably over two or three decades, with power distributed evenly over the band
2) Provision to tailor the bandwidth of excitation as per the application.
3) Improved signal to noise (S/N) ratio of the measured signal in addition to the ability to reject uncorrelated noise “Tellurics” in field.
4) The IP phase angle spectrum over useful and normal band of frequencies is obtained at one time in the field.
(5) The process of removal of the inductive coupling effects in the field can be made very effective as the discrete phase spectrum obtained is composed of several closely spaced frequencies.
6) Current source and receiver are synchronized using precision GPS time and frequency references in order to eliminate physical linking between current source and receiver through a cable, thus facilitating easier and faster field surveys.
7) This invention facilitates a novel technique and device for the exploration of disseminated ore bodies, ground water, hydro carbons and pollution studies.
8) The present invention also gives a mean accuracy of measurements better than 1% in band-I and 2% in band-II.

### References:

[1] W. H. Pelton, S. H. Ward, P. G. Hallof, W. R. Sill, and P. H. Nelson, “Mineral discrimination and removal of Inductive coupling effects with Multi frequency IP”, vol3, pp588-609, Geophysics, April 1978.
[2].Vanvoorhis, G. D., Nelson, P. H. and Orake, T. L. “Complex Resistivity spectrum of poryphyry copper mineralization”: GEOPHYSICS, 1973, V.38, PP 49-60.
[3].M. R. Foster, and R. N. Sloane, “The use of Pseudo noise sequences to code a pulsed neutron source” vol 37, pp481-487, Geophysics, 1973.
[4]. E. A. Quincy, W. H. Davenport, and T. E. Lindsay, “Preliminary field results for a new transient induction system employing pseudo noise signals”, IEEE.
[5]. P. M. Duncan, A. Hwang, R. N. Edwards, R. C. Balley, and G. D. Garland “The development and application of wide band EM sounding system using a pseudo noise source”, vol, pp 1276-1296, Geophysics, 1980.

We claim:

1. A device for the measurement of spectral induced polarization response using Pseudo Random Binary Sequence (PRBS) current source, which comprises a PRBS current source and a receiver, the said current source includes an alternator (1) connected to a high voltage supply (2) and also to a low voltage power supply (3), which is further being connected to insulated gate bipolar transistor (IGBT) driver (7), the said driver (7) being connected from one side to three inter-connected components, consisting of Precision GPS time and frequency reference (4), scalar/divider (5) and PRBS generator (6), and from the other side being connected to IGBT current switching bridge (8) for the excitation of the subsurface, the said receiver system being a digital correlator of reference and signal channels for computing electrical transfer function of the subsurface which includes precision GPS time and frequency reference (9) connected to scalar/divider (10), which is further being connected to PRBS generator (11), the said generator (11) being further connected to a sample timer (10), pre-amplifier (13), SP compensator (13), amplifier (14) and matched anti-aliasing filters (12,15), the said filter being further connected to a Multi-function data acquisition Personal Computer memory card international Association Card (PCMCIA) (16) and a lap top computer (17).

2. A process for measurement of spectral induced polarization response using Pseudo Random Binary Sequence (PRBS) current source according to claim 1, wherein the uncorrelated noise is rejected by using correlation method; and thereby signal/noise ratio is improved substantially as the stacking process is used, gives the phase angle of the subsurface over useful and normal band of frequencies at a time in the field.

3. A process for measurement of spectral induced polarization response using Pseudo Random Binary Sequence (PRBS) current source according to claim 2, wherein high voltage power supply (2) supplies DC Voltage of up to 500 Volts at 1 A to the IGBT bridge.

4. A process for measurement of spectral induced polarization response using Pseudo Random Binary Sequence (PRBS) current source according to claim 2, wherein low voltage power supply (3) as +12 Volts DC is supplied to IGBT bridge driver circuit.

5. A process for measurement of spectral induced polarization response using Pseudo Random Binary Sequence (PRBS) current source according to claim 2, wherein precision GPS time and frequency references (4,9), generate 10 MHz clock with a stability of 1 in 10″ and is supplied to scalar/divider.

6. A process for measurement of spectral induced polarization response using Pseudo Random Binary Sequence (PRBS) current source according to claim 2, wherein scalar/divider (5, 10) generate clocks of 4 Hz and 200 Hz.

7. A process for measurement of spectral induced polarization response using Pseudo Random Binary Sequence (PRBS) current source according to claim 2, wherein PRBS generator (6, 11) input is taken from Scalar/divider and Pseudo Random Binary Sequences of lengths 31, 63 and 127 are generated.

8. A process for measurement of spectral induced polarization response using Pseudo Random Binary Sequence (PRBS) current source according to claim 2, wherein IGBT driver (7) trigger pulses as per the input PRBS sequence are generated.

9. A process for measurement of spectral induced polarization response using Pseudo Random Binary Sequence (PRBS) current source according to claim 2, wherein IGBT current switching bridge (8) current is switched alternately (+ −) into the ground through current electrodes (AB) on getting trigger pulses from the driver.

10. A process for measurement of spectral induced polarization response using Pseudo Random Binary Sequence (PRBS) current source according to claim 2, wherein over load protection built into the IGBT driver (7) current is sensed and triggers to the IGBT bridge are switched OFF in case current exceeds the limit.

11. A process for measurement of spectral induced polarization response using Pseudo Random Binary Sequence (PRBS) current source according to claim 2, wherein pre-amplifier (13) high input impedance is presented to the received signal from potential electrodes (MN) which is amplified 10 times with low noise output.

12. A process for measurement of spectral induced polarization response using Pseudo Random Binary Sequence (PRBS) current source according to claim 2, wherein SP compensator (13) cancels self potential of the ground up to maximum of +750 mV to −750 mV.

13. A process for measurement of spectral induced polarization response using Pseudo Random Binary Sequence (PRBS) current source according to claim 2, wherein amplifier (14) provides gains of 1, 10 and 100 which can swing up to ±5 Volts to the output signal from pre-amplifier.

14. A process for measurement of spectral induced polarization response using Pseudo Random Binary Sequence (PRBS) current source according to claim 2, wherein sample timer (10) generates sampling pulses for Data acquisition and clock pulses for anti aliasing filters.

15. A process for measurement of spectral induced polarization response using Pseudo Random Binary Sequence (PRBS) current source according to claim 2, wherein data acquisition card (16) residing in PCMCIA slot of laptop computer converts analog samples from reference and signal channels into digital data with 16 bit resolution.

16. A process for measurement of spectral induced polarization response using Pseudo Random Binary Sequence (PRBS) current source according to claim 2, wherein auto and cross correlation estimates of acquired data are computed.

17. A process for measurement of spectral induced polarization response using Pseudo Random Binary Sequence (PRBS) current source according to claim 2, wherein sub-surface is excited with PRBS current waveform, the power distributed evenly through out the band 0.03 Hz to 100 Hz and provision is made to tailor the band width of excitation as per the application.
